(19) United States
(12) Patent Application Publication
(10) Pub. No.: US 2016/0265582 A1
(43) Pub. Date: Sep. 15, 2016

(54) Sectional Door Hinge System

(71) Applicant: Sherif Abdalla, Carlsbad, CA (US)

(72) Inventor: Sherif Abdalla, Carlsbad, CA (US)

(21) Appl. No.: 15/062,638

(22) Filed: Mar. 7, 2016

Related U.S. Application Data
(60) Provisional application No. 62/133,316, filed on Mar. 14, 2015.

(51) Int. Cl. F16C 11/04; E05D 7/10; E06B 3/48

(52) U.S. Cl. CPC F16C 11/04; E06B 3/485; E05D 7/10; E05Y 2900/106

(57) ABSTRACT

A sectional door hinge system is provided which is engageable between upper and lower portions of a sectional door configured for rolling in a track abutting a door jamb. Each hinge is actuatable to move from an engaged position preventing separation of the hinge to a configuration allowing separation between two sections forming the hinge. Separation of the hinge sections allows movement of the upper portion of the sectional door, independently of the lower section. The door hinge system may be retrofit to existing sectional garage doors and provided with newly manufacture garage doors.

### BACKGROUND OF THE INVENTION

1. Field of the Invention

This application claims priority to U.S. Provisional Patent Application Ser. No. 62/133,316, filed on Mar. 14, 2015 which is incorporated herein in its entirety by this reference thereto.

The present invention relates generally to sectional roll-up doors employed on buildings to provide access thereto. More particularly it relates to pivoting connector and method enabling the separation of portions of such roll-up doors, thereby allowing an upper section to translate to its elevated position with a lower section to remaining in place adjacent the surface ground or driveway leading through the roll-up door.

2. Prior Art

Doors providing entry to home and business garages have been employed for decades. Conventionally, three types of garage doors have been widely employed and these include a one-piece door, a flexible roll-up door, and the sectional door.

Sectional garage and building doors are conventionally formed of a plurality of door sections in hinged engagement to each other.

Residential sectional doors such as those employed for garage entry conventionally are formed of four or five individual sections. However, some can have more and some less depending on the door opening height.

In operation to open or to close in a doorjamb of a garage or building, the sections of such sectional doors are in a hinged engagement to each other and in the closed or down position, they are stacked vertically. To translate the door to an elevated position, where access is provided through the doorjamb, or to a closed position blocking the doorjamb, the door sections are engaged to rollers about a side edge which follow a track positioned adjacent the vertical sides of the door jamb defining the door opening.

In operation, to move the door from a closed or vertical position where a leading edge of the lowest section of the vertically stacked panels is adjacent the ground or driveway to a raised or elevated position with the leading edge elevated above or adjacent a top edge of the doorjamb, a force is communicated in the desired direction of travel of the door by a user or by an operatively engaged opening device. While the force is exerted to the pivotally engaged sections, the rollers in operative engagement with the door travel along the track and both support and maintain the sections in alignment while the door is repositioned. Conventionally, in closing or opening a sectional door, the entire door consisting of all engaged sections is moved as a unit. In doing so, the door assumes either the elevated or open position as a complete unit, or the vertical or closed position.

As noted, the individual sections are pivotally engaged to adjacent sections, using a pivoting engagement such as hinges. These hinges allow the individual sections to pivot in relation to each other as the wheels engaged with the track follow within a curved portion thereof. This pivoting engagement thereby enables the individual sections to bend as the door is elevated or closed. To lessen the force required to raise or lower the door, conventionally a cable is engaged to the door which operates a counterbalancing device such as a spring to store energy as the door is lowered. The same cable exerts the force of the stored energy as the door is subsequently raised thereby lessening the amount of force required to do so.

However, a shortcoming exists in the design and operation of such sectional doors, in that the door must be raised or lowered in their entirety where all sections are either raised out of the way of the doorjamb, or lowered and block the entire doorjamb. If the building owner or homeowner wishes to allow air passage to the garage or building through the doorjamb, currently they can only raise the entire door partially, thereby forming a gap between the leading edge of the lowest-positioned door section and the ground. The same is true should they wish to allow ambient light through the doorjamb.

This partial opening is problematic for a number of reasons. First, a passage is left completely open at the ground or driveway surface between the garage and the exterior of the home or building. Such allows animals, children, or others easy access through the doorjamb and into the building. This can be dangerous since small children might be able to leave the home or building, or animals can get into the building and be trapped when the door is subsequently closed, or cause damage while inside the building.

As such, there exists an unmet need, for a system providing a method and device which once engaged to a sectional garage or building door, will enable owners of buildings having segmented or sectional doors, to open the sectional door entirely or partially leaving the leading edge and a portion of the sectional door adjacent the ground surface in the doorjamb. Such a system should allow for easy user activation using a single control. Such a system should allow for an easy transition of the door from the lowered position, to the elevated position, either partially where airflow and ambient light transmission is desired, or completely where the entire door is raised to allow a vehicle or other object to be rolled through the doorjamb. Such a system by allowing a lower portion of the sectional door to remain in place adjacent the ground, and an upper portion of the sectional door to be raised, will thereby prevent children and animals and even unwanted adults from traversing through the doorjamb when the lower portion of the door is left in place, yet will provide excellent communication of both ambient light, and airflow into the room serviced by the doorjamb since both will flow through the upper half of the doorjamb.

The forgoing examples of related art and limitations related therewith are intended to be illustrative and not exclusive, and they do not imply any limitations on the invention described and claimed herein. Various limitations of the related prior art will become apparent to those skilled in the art upon a reading and understanding of the specification below and the accompanying drawings.

### OBJECTS OF THE INVENTION

It is an object of this invention to provide a method for raising and lowering a sectional door in a doorjamb, in a manner where a lower half of the sectional door may be left in place adjacent the ground, while the upper half may be raised to open only an upper portion of the doorjamb.

It is a further object of this invention to provide a device to enable the automatic raising or lowering of either the upper half portion of a sectional door, or the entire door, automatically.

It is yet another object of this invention to provide a method or means to retrofit existing hinged sectional doors, to provide the ability to raise and lower only the upper half of the door, or the entire door, at the user's choosing.

It is a further object of this invention to provide a device engageable with sectional roll-up doors, which provides or activation by a user to separate the door, from a single control or position.

It is yet another object of this invention, to provide separable components which allow for separation of a sectional door to two components, and which self-engage once the door is closed to reform the door to a single, but a separable sectional door.

These and other objects, features, and advantages of the present sectional door hinge invention and system herein, as well as the advantages thereof over existing prior art, which will become apparent from the description to follow, are accomplished by the method and/or improvements described in this specification and hereinafter described in the following detailed description which fully discloses the invention, but should not be considered as placing limitations thereon.

### SUMMARY OF THE INVENTION

The disclosed device and method herein provide for the configuration of a sectional door, to change between a single door section rollable as a single unit, to a separated configuration having a plurality of rollable door sections. In the separated configuration, the sectional door has an upper section which may be moved to the elevated or raised position independently, thereby positioning a lower door section adjacent the ground at the bottom of the doorjamb. Using the separable hinge components herein, from a single activation point or control, the sectional door may be actuated to form the plurality of door sections, to allow for raising only an upper portion, or because the separable hinges herein automatically re-engage upon closure of the door, the upper section and lower section of the door may also be moved as a single unit, between the lowered and elevated positions.

Employing the disclosed separable pivoting connector or hinge system and device herein, sectional doors such as those employed on garages, can be manufactured to include the components herein allowing for actuation and independent translation of an upper section to the elevated position. Using only the disclosed hinges herein, adapted for engagement to sectional doors, existing sectional doors can also be easily retrofitted to include the components herein allowing for separation of an upper section from a lower section of a sectional door.

As such, using the separable hinge components herein, which are actuated to separate from a single control or an actuator, either in newly manufactured doors, or by retrofitting existing sectional doors, the user has the option of translating only the upper section to the elevated position, or, both the upper and lower sections concurrently, between the elevated or lowered position. Subsequent to each closing of the door, and placing the upper section adjacent or abutting an edge of the lower section, the separable hinges herein in all modes automatically re-engage thereby configuring the sectional door to a single section.

The system herein may be actuated by hand using a single actuation component, to cause a separation of the separable hinges engaged upon a central area of the door, and thereby allow the door to separate into two sections. t should be noted, that rather than separating the hinges at a pivot, that the actuator could also disconnect one side of the hinge from its connection to the lower or upper section, and allow for separation of the upper and lower door sections. This mode would leave the hinge in a pivoting engagement, but only connected to one of the upper or lower sections of the sectional door. While this mode would position one edge of the pivotally engaged hinge projecting past the edge of the upper or lower section, which is not as desirable as separation at the pivot point, it would still allow for separating and rejoining the upper and lower sections of the door using an actuator which would simply disconnect one side of the hinge from its engagement with a door section.

In an automated mode where the separable pivots or hinges separate into two portions, electric actuators which may be activated by remote control to separate respective engagements of the plurality of separable hinges engaged between the upper section and the lower section of a sectional door.

Using the mechanically actuated system herein, an actuator may be located on each hinge, or a centrally located separable hinge connected to the other hinges, may be engaged with a handle on the interior, or if desired, on the exterior of the door. The separable hinges on either side of the centrally located hinge, are concurrently actuated to separate through connections to the centrally located separable hinge. Thus, from a single point on the sectional door, the user may actuate all the separable hinges concurrently to move to a disengageable configuration, and allow the upper door section and lower door section to separate. When the upper section is closed and rolled to contact the lower section, the force of contact therewith will cause all the separable hinges to concurrently re-engage.

In a remote control mode of the device herein, electric motors or solenoids or other electric actuators adapted to the task of rotating internal components of the hinges to separate them, may be employed. A single motor may be engaged with the centrally located hinge to actuate it, and the connected separable hinges on each side, to separate. Alternatively, all hinges could have their own motor engaged.

The motor will be connected to electrical power through a remotely actuated switch such as a conventional remote control, or garage door opener. Actuating the remote control will thus actuate the motor or motors on the door to move the components of each separable hinge to a separable configuration allowing for the upper door section to be translated to an elevated position independent of the lower door section. The actuator switch may be employed in concert with an automatic door opener switch such that when the electric door opener is activated, either the upper section alone, or the upper section, pivotally engaged with the lower section of the door, are raised to the elevated position.

Alternatively, but not preferred, each of the actuators on each hinge may be manual. In this mode the user will simply push or pull mechanical actuators which will cause the operatively connected internal components of the separable hinge, to move to the configuration allowing disconnection of the two halves of separable hinges joining the upper section of the door to the lower section of the door. Thereafter the upper section of the door may be raised manually and the lower left in place, or the automatic opener can be activated to pull the upper section to the open or elevated position.

As noted above, each separable hinge is configured such that a lowering of the upper section of the door to abut or contact the lower section of the door, will cause each separable hinge to automatically engage both halves to the locked or non-separable configuration. If the hinge is left in a pivoting connection and one side or the other is disconnected from a respective door section, a repositioning of the upper section to abut the lower section will cause latch to contact and rotate and the latch into position to re engage with a lock, pin, or connection holding it in pivoting position around the member. Spring loading a pin or lock in a manual mode to return to engagement with the latch, or having the motor reverse and reposition the pin with the latch, or other means for automatic locking of the latch to prevent rotation are preferred so that the door automatically re-engages.

By automatically re-engaging the pivoting connector halves, or the pivoting hinge to the door section, it protects the user from accidentally leaving the upper section disconnected from the lower section. Further, by default, if the upper section of the door abuts the lower section of the door, it rotates all latches to re-engage all members thereby assuring the entire door will move as a single section when raised.

A lock may be provided to hold the lower section of the sectional door in position, with a leading edge of the lower section of the door in contact with or adjacent to the floor of the doorjamb. Such will allow the lower section alone, or the entire door where the lower and upper sections are joined, to be locked into a lowered position blocking part of or all of the doorjamb.

Additionally, sensors to stop door translation should an object be sensed in the doorjamb and in the path of the lowering door may also be employed such as infrared sensors, and sensors engaged with the motor raising or lowering the door which sense excessive electrical current draw which occurs when the pathway of the door is blocked.

In a method herein, such as a retrofit of an existing door, an upper section of a sectional door will be joined with a lower section thereof, using separable hinges which may be actuated to a separable configuration from a connected or locked configuration. This may require the step of removing the existing plurality of hinges at a desired point of separation between the upper section and lower section of the sectional door. Once the hinge devices herein are installed in a plurality along the line of separation between the upper and lower sections of the sectional door, thereafter, to raise just the upper section of the sectional door only, actuators separating two halves of each of the separable hinges will be actuated to cause internal components to move to the separable configuration. Thereafter the upper section of the sectional door may be raised by sliding it in an engagement of rollers thereon in a track, to an elevated position to form a gap between a first edge of the upper section and a separation edge of the lower section.

In another step the two sections of the sectional door may be rejoined to a single door component automatically by lowering the upper section such that the first edge of the upper section abuts the separation edge of the lower section of the door. During contact or proximal positioning of the two door sections, the two half portions of each of the plurality of separable hinges are aligned and a contact therebetween causes them to be automatically actuated to the locked or connected position. In this fashion, the two half portions of each of the separable hinges are locked in a pivotal engagement. With the separable hinges locked in engagement, the entire door may be elevated with both sections engaged, or, the plurality of separable hinges may be re-actuated for separation to allow only the upper portion to be raised.

Finally, in another mode of the device herein, a screen may be included which may be actuated to fill the gap formed between the separation edge of the lower portion of the door, and the open area or gap within the door jamb. The screen can be stored on a roll which can be unrolled by hand, or may unroll automatically once the upper portion of the door is raised to the elevated position. The screen would be retracted to the roller on which it is stored prior to closure of the upper portion of the door.

With respect to the above description, before explaining at least one preferred embodiment of the herein disclosed sectional door separating system in detail, it is to be understood that the invention is not limited in its application to the details of construction and to the arrangement of the steps in the following description or illustrated in the drawings. The separable hinges enabling separation of a sectional door herein described are capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing and carrying out separable sectional door systems. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts a perspective view of a sectional door having the separable hinge device herein engaged, wherein an upper portion may then be moved separably to an elevated position separated from a lower portion.

FIG. 2 depicts a view of the sectional door of FIG. 1 wherein the upper portion is returned to a pivotal engagement to the lower portion of the sectional door, using a plurality of the separable hinge devices engaged therebetween.

FIG. 3 depicts an overhead view of a separable hinge device actuated to a pivotally engaged position.

FIG. 4 depicts the separable hinge of FIG. 3 wherein an actuator has been actuated to allow the hinge to move to a separated configuration wherein a first portion of the separable hinge is dispensed from a second portion thereof.

FIG. 5a depicts a view of the separable hinge as in FIG. 3, showing the latch operationally engaged upon the member of the second hinge component, and held by a connection such as a pin, to form a pivoting connection with the member engaged with the first hinge component.

FIG. 5b depicts a view of the separable hinge actuated to a disengageable or separable configuration, wherein the pin engaged with a slot on the latch has been disengaged by operation of an actuator, and the latch is rotatable to the position of FIG. 5c, by the force of the upper section moving upward to disengage the member of the first latch component.

FIG. 5c depicts a view of the separable hinge as in FIG. 4, showing rotation of the latch on the second hinge component 34 to disengage from its pivoting engagement with the member engaged with the first latch component, and moved to a disengaged configuration.

FIG. 6 depicts the separable pivot or hinge of FIGS. 3-5 wherein an actuator has been actuated to lock or hold the complimentary latching components of the first portion of the separable hinge with those of the second portion of the separable hinge which are held in a biased locked configuration by biasing members such as springs.

FIG. 6a is a perspective view of the hinge herein with exterior parts removed for clarity showing the inner components.

FIG. 7 depicts a lock which may be automatically actuated to engage a latch positioned on the door jamb to a translating member in a locked engagement, thereby preventing translation of the lower portion of the sectional door from moving to the raised or open position.

FIG. 8 depicts the lock of FIG. 7 actuated to the unlocked position allowing movement of the lower portion of the sectional door to a raised or open position when the upper portion is raised.

FIG. 9 shows positioning of a plurality of the separable hinges in an engaged position between the upper and lower portions of the door, the hinges are connected whereby actuation of one hinge to a separable configuration, will move all the engaged hinges from the non-separable configuration shown in FIGS. 10 and 11.

FIG. 10 depicts a plurality of hinges such as in FIG. 9, concurrently moved to the separable configuration by movement of the actuator or handle on one such as the centrally located hinge which is operatively connected to the adjoining separable hinges in the plurality.

FIG. 11 depicts the plurality of separable hinges engaged to the door, moved to a separable configuration of FIG. 10, and the initiation of separation of the two portions of the door.

FIG. 12 depicts an optional deployable screen, configured to fill the opening between the lower portion of the door and the door jamb, once the upper portion of the door has been raised. Other aspects of the present invention shall be more readily understood to those skilled in the art when considered in conjunction with the above noted accompanying drawings, and the following detailed description, neither of which should be considered limiting in any fashion whatsoever.

### DETAILED DESCRIPTION OF THE PREFERRED EMBODIMENTS OF THE INVENTION

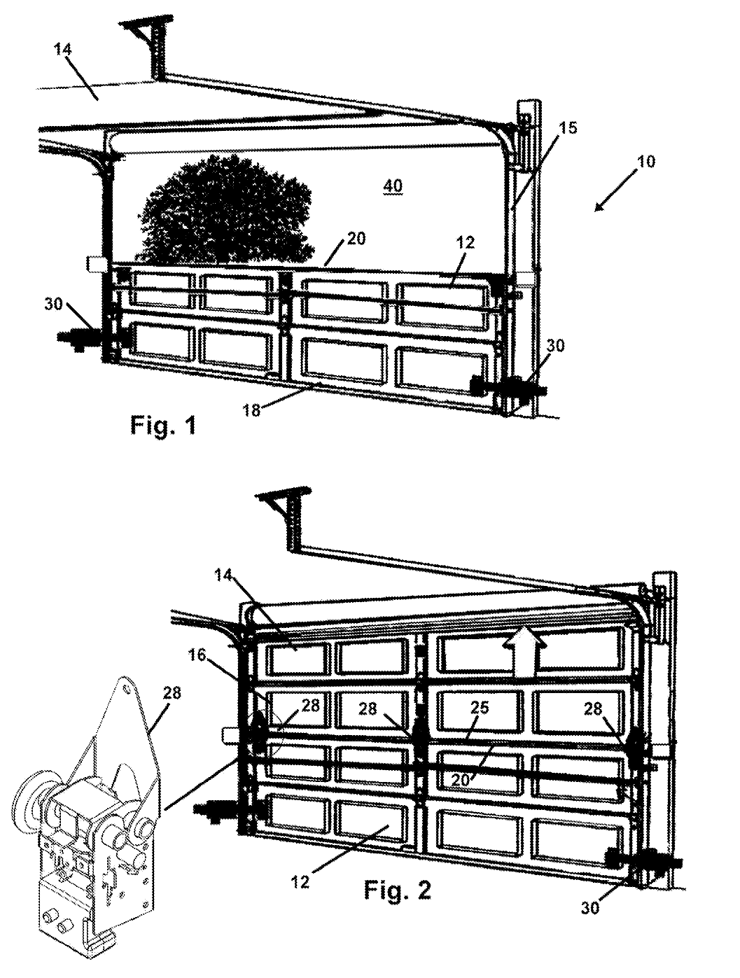

Now referring to drawings of FIGS. 1-12, where similar structures are labeled with like numerals there is seen in FIG. 1, a perspective view of a sectional door 16 widely used for garages and the like, which in the system herein includes a separable lower portion 12, in a typical view looking from inside the room which the sectional door 16 provides access from outside the structure.

It should be noted, that the object of this invention is the provision of a separable pivotal connection between and upper portion 14 and lower portion 12 of a sectional door, to allow independent movement of each once separated. While the action of separation is primarily described as the disengagement of a pivoting connection between two halves of a pivot or pivoting hinge, the actuator herein can also be configured to uncouple or disengage one of the two halves of the pivoting hinge from its respective connection to one of the upper portion 14 or lower portion 12 of a sectional door 16, and thereby provide the utility allowing the upper portion 14 to be translated away, or raised on its track, to form a gap between it and the lower portion 12 which remains at the bottom of the door jamb.

However separating one side of the pivoting connector or hinge 28 from a removable engagement with one of the upper portion or lower portion of the door 16, will leave a portion of the hinge 28 extending from or adjacent the edge of the upper or lower portion of the door 16, which may not be desirable for safety and other concerns.

Consequently, the separable hinge 28 herein described which can separated by release of a pivoting engagement between the two halves of the hinge 28, is more preferable since this mode positions all components away from any projection beyond an edge.

In the view of FIG. 1, an upper portion 14 of the sectional door 16 shown in FIG. 2, has been moved to a second, or elevated position, forming a gap between the upper portion 14 and lower portion 12. The gap of course is removed once the upper portion 14 is repositioned to a first position adjacent the lower portion 12, and the hinges 28 themselves or one side thereof are re-engaged.

This separation and movement has been accomplished using the system herein wherein employment of an actuator configures the pivoting connections or hinges to allow disconnection of the separable hinges 28 herein disclosed. Actuation allows each pivoting connector or hinge 28 to release from a configuration in a locked pivoting engagement connecting the two sections of the sectional door 16. As noted, this disengagement may be either a disengagement between the pivoting engagement of the two halves of the hinge 28 as depicted, or, a disengagement of one of the two pivotally engaged halves, from its respective connection to one of the upper or lower door sections.

As noted the hinges 28 can be included in the construction of brand-new sectional doors 16, or they may be adapted to engage upon existing sectional doors 16, in place of the non separable hinges thereon, to enable existing sectional doors 16 to achieve separation into an upper portion 14 and lower portion 12.

In the depicted separated configuration of the sectional door 16, of FIG. 1, the lower portion 12 of the door is positioned vertically within the door jamb 15 with a leading edge 18 positioned adjacent the floor or ground, and on an opposite side therefrom, a separation edge 20 is elevated above the position of the leading edge 18. In this separated configuration, subsequent to disconnecting the pivoting connector or one half of a formed hinge engaged to one section of the door, the lower portion 12, blocks access through the doorjamb 15 by small animals, children, objects, and others not able to step or climb over the elevated separation edge 20.

In FIG. 2 is shown a view of the sectional door 16, wherein a first edge 25 of the upper portion is in a pivoting engagement abutting the separation edge 20 of the lower portion 12 of the sectional door 16. This pivoting engagement is provided by the pivoting connections between two halves of the separable hinges 28 engaged therebetween. As noted, the separable hinges 28 herein, can be engaged to the sectional door 16 during manufacture, or in a particularly preferred mode of the system herein, the separable hinges 28 will be adapted to engage an existing sectional door 16, at a determined separation edge 20, by the user who will remove the existing non-separable hinges in a first step, and engage the separable hinges 28 herein along the separation edge 20 in a second step. Holes in the two separable hinge 28 halves will align with bolts employed on existing doors. In a third step, the locks 30 noted below may be operatively engaged, to secure the lower portion 12 from movement when the upper portion 14 is separated from the lower portion 12. Of course many types of locks might be employed other than those herein if locks are desired such as for example, magnets on the floor under the edge of the door which are strong enough to hold the lower portion in place.

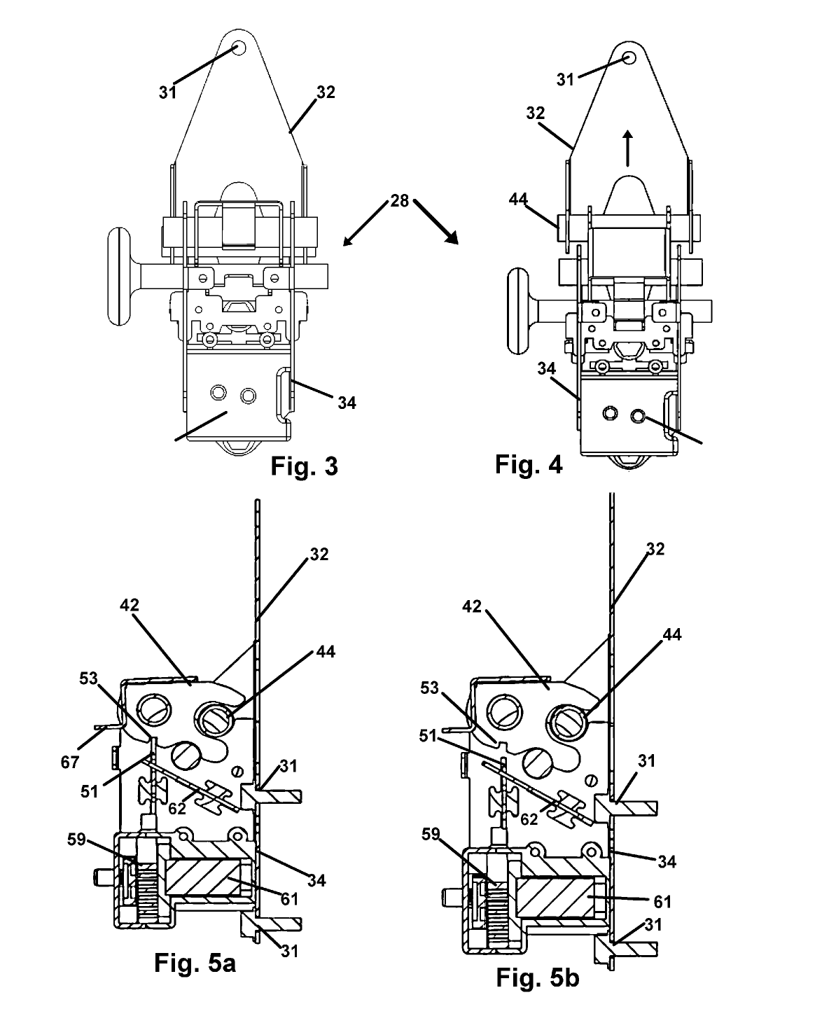

To adapt the separable hinges 28 for engagement in the place of existing hinges on a sectional door 16, the mounting holes 31 (FIGS. 3-5) can be positioned in the halves of the separable hinge 28 to register with the receiving holes in the sectional door 16 for the existing conventional hinges. Or, adapters can be provided with the separable hinges 28, which will connect to the mounting holes 31 at one position, and the receiving holes on the sectional door 16 for the bolts holding the removed conventional hinges. This retrofit mode of the system herein, thus will not include the sectional door 16 nor the cost for such, and will allow the existing hinges of a sectional door 16, to be removed along a separation edge 20, and the separable hinges 28 herein to be positioned in their place, to give the user the significant utility of being able to separate their existing sectional door 16 into half portions. Once the separable hinges are operationally engaged along the separation edge 20 of the existing sectional door 16, they can be individually actuated to a configuration allowing disengagement for example as described herein, or the plurality of separable hinges 28 installed adjacent to the separation edge 20, can be engaged to each other such as shown herein, to move between the separated or engaged positions.

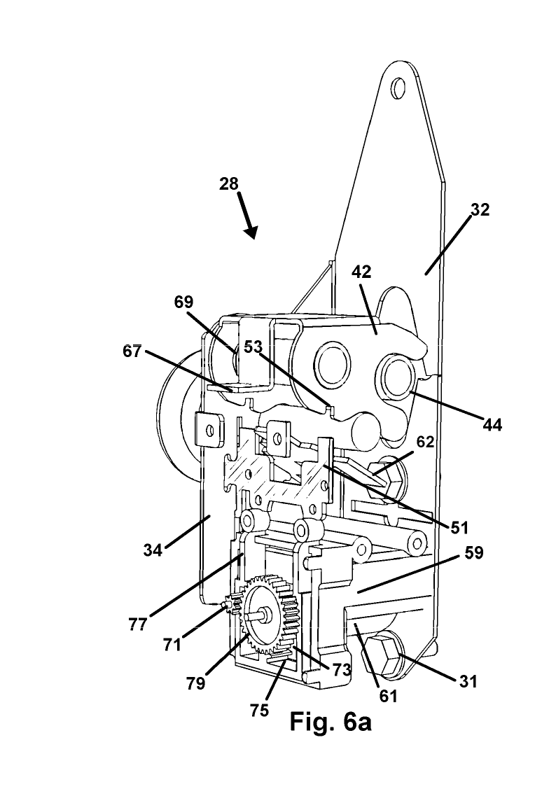

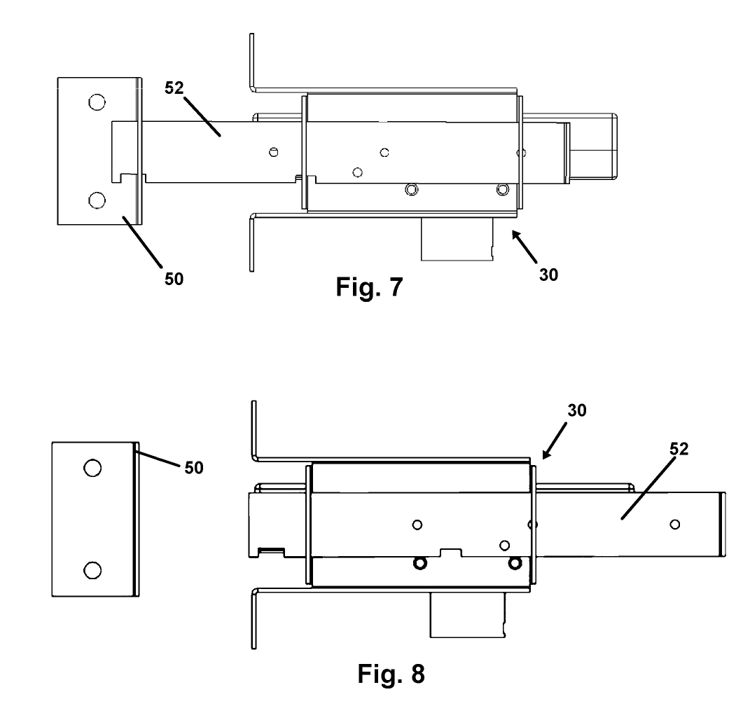

Also shown in FIGS. 7-11 are a lock 30 which is engageable to form a locked engagement between the lower portion 12 of the sectional door 16, and the door jamb 15 to prevent translation of the lower portion 12 to the elevated position when the door is separated. When not separated, the locks 30 are disengaged, and the leading edge 18 or bottom of the lower door, can be located above or adjacent to the top horizontal edge of the doorjamb. When the plurality of separable hinges 28 are in an engaged position, such as in FIGS. 3 and 6, the upper portion 12 of the sectional door 16 is also prevented from translation to the open or elevated position by locks 30 if engaged.

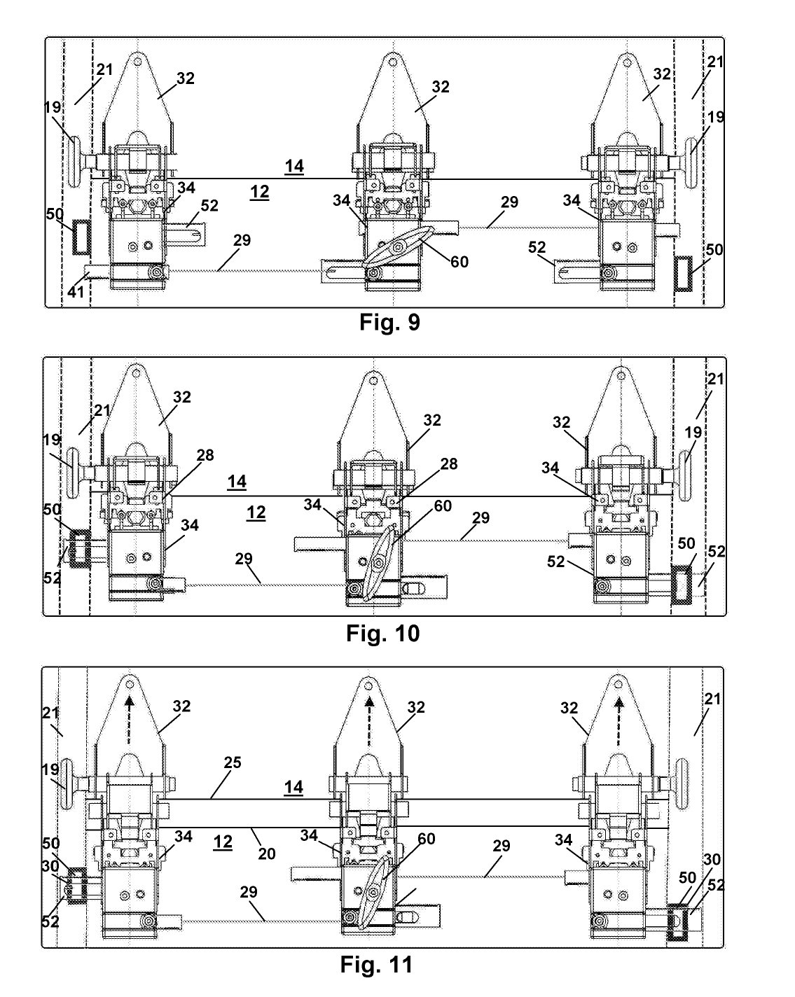

While the locks such as in FIGS. 7 and 8 can be manually operated by sliding, if the locks are not engaged to the hinges 28, concurrently actuatable locks 30 which translate with actuation of the hinges 28 can also be employed and are depicted in another preferred mode in FIGS. 9-11. Of course if the user wishes to hold the lower portion 12 against the ground while translating the upper portion 14 to the elevated position, the locks 30 shown or other locking mechanisms could be optional, but are preferred.

It should be noted that all descriptions herein of operation of the separable hinges 28 and the sectional door 16, can be for such separable hinges 28 which are included with a newly manufactured sectional door 16, or a sectional door 16 which has been retrofitted with the sectional hinges 28 herein. Also, while preferred configurations of the separable hinge 28 and its operation to actuate between a locked or engaged configuration, and a separable configuration are herein described, other configurations which will lock two portions of a pivoting connecter or separable hinge 28 in a non separable pivoting engagement, and unlock the two hinge portions and allow a separation thereof and employable and those skilled in the art on reading this disclosure will surely arrive at such. As such, any separable pivoting connector or separable hinge 28 which has a locked position preventing separation, and can be actuated to a separable configuration by an actuator, is considered within the scope of this application when positioned upon the separation edge 20 of a sectional door 16.

In FIG. 3 can be seen an overhead view of a separable pivot or separable hinge 28 configured in a pivoting and engaged position such as in FIG. 6, wherein a first hinge component 32 locked in an operative pivoting engagement with a second hinge component 34. The first hinge component 32 is preferably engaged adjacent a first edge 25 of the upper portion 14 of the door, and the second hinge component 34 is engaged with the lower portion 12 of the sectional door 16 adjacent the separation edge 20 thereof. So engaged, the plurality of separable pivoting connectors such as the separable hinges 28 will maintain the adjacent sections of the sectional door 16 proximate to each other. However, either hinge component can be engaged on either of the upper or lower portion with the other half of the hinge component engaged to the other of the upper or lower portion.

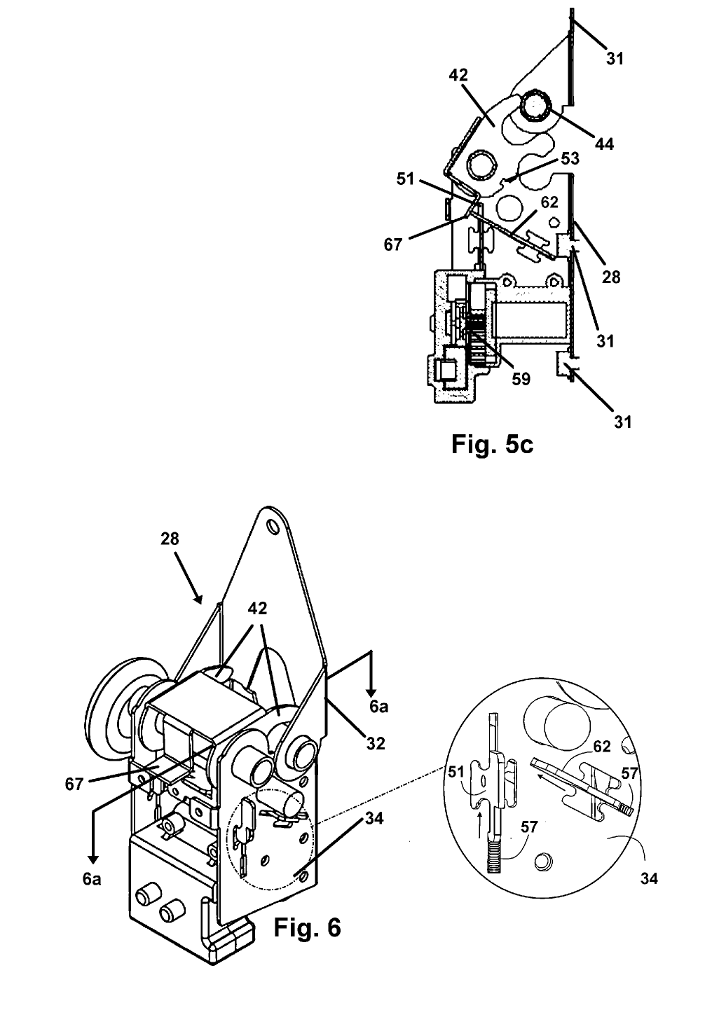

As shown in FIG. 3, and the sectional view of 5a, the separable hinge 28 has a first position or engaged configuration, where the first hinge component 32 is prevented from separation from the second hinge component 34 and concurrently maintained in a pivoting engagement with the second hinge component 34. In FIG. 4 and in FIG. 5b movement of an actuator causes translation of an pin 51 to position the separable hinge 28 to a second or disengaged configuration. In the separable configuration, the first hinge component 32 is separable from the second hinge component 34 by forcing the upper door in a direction away from the lower door which rotates. The pin 51 restrains the latch 42 which is biased by a spring to move to the open or separable configuration, and once disengaged from the latch 42, any upward movement of the upper section will cause it to rotate.

With the separable hinges 28 engaged between the upper portion 14 of the sectional door 16 and the lower portion 12 of the sectional door 16, and the plurality of separable hinges 28 in this disengaged position, a force against the upper portion 14 of the door 16 will further disengage the two halves of the separable hinge 28 and the upper portion 14 of the door 16 will slide in a roller 19 engagement with a track 21, to an elevated or open position of FIG. 1. Concurrently, the lower portion 12 of the door 16 will remain positioned with a leading edge 18 on or adjacent the ground or floor of the doorjamb 15, and the separation edge 20 elevated above the leading edge 18. As noted the lower portion 12 may be held in place by the user, or by a lock 30 described herein or other means for resisting upward movement such as magnets or other locks. This separation between the upper portion 16 and lower portion 12 of the door 16, enables the opening 40 of FIG. 1, to be formed. Operation of the releasable pivoting connection of the two components of the separable hinge 28 from the locked or engaged configuration of FIG. 5a, to the disengaged configuration of FIG. 5c, can be seen in FIGS. 5a-5c. As shown in FIG. 5a, the separable hinge 28, is actuatable between an engaged configuration of FIG. 5a, wherein a releasable pivoting connection between the first hinge component 32 and the second hinge component 34, is formed by a latch 42 connected to the second hinge component 34 which is rotationally engaged with a member 44 attached to the first hinge component 32. A disengageable lock or pawl, to hold the latch 42 which is biased by a spring to rotate upward to disengage the member, can be provided by a pin 51 which is engaged within a slot 53 formed in the latch 42, and locks the biased latch 42 in a releasable pivoting connection encircling the member 44 positioned on the first hinge component 32. In the unlocked configuration with the pin 51 disengaged, any upward movement of the member 44 will cause the biased latch 42 to rotate open to release the member 44. Other locks which can be disengaged by an actuator and disengage the two sides of the separable pivot or hinge, can also be used and are anticipated within the scope of this invention.

FIG. 5b depicts a view of the separable hinge 28 subsequent to operation of an actuator 59 which is depicted as a gear train operatively connected to overcome the force from a biasing member 57 (FIG. 6) and translate the biased pin 51 out of the slot 53, thereby moving the hinge component 28 to an unlatched configuration. The gear train defining an actuator 59 in this mode, is powered by an electric motor 61, however other actuators 59 connected to overcome bias from the spring or biasing member 57 and unlock the biased pin 51 from the latch 42 such as a handle, or solenoid, or manual contact with the pin 51 by the hand of a user, might also be employed. As shown, rotation of the gear train defining one useable actuator 59, by the motor 61, acts to overcome the bias of the spring or biasing member 57 forcing the pin 51 into the slot 53, and translate the pin 51 from the slot 53. This disengagement allows the latch 42, which is biased by a spring 69 (FIG. 6a) to rotate and disengage the member 44, to rotate and disengage when the member 44 and the upper portion of the sectional door, starts translation toward the top of the door jamb.

FIG. 5c depicts a view of the separable hinge 28 as in FIG. 4, showing the biased latch 42 rotated on the second hinge component 34 to a position to disengage and break the pivoting connection with the member 44 engaged with the first latch component 32, and moved to disengaged position. As can be seen in this view, in this mode the upwardly biased pin 51 is forced by an actuator to translate out of the slot 53 through contact or movement of the actuator 59 to overcome the force of a spring or biasing member 57 (FIGS. 6).

During this disengagement sequence, a positioning member 62, temporarily holds the pin 51 out of engagement with the slot 53, until the latch 42 rotates upward sufficiently where a plate 67, engaged to the latch 42, will translate the positioning member 62 out of contact with the pin 51 which is then biased against the edge of the latch 42. So positioned, in biased contact with the edge of the latch 42, the pin 51 will re engaged the slot 53 on the latch 42, once it is forced downward by the force of the member 44. During this disengagement of the latch 42 which is biased to rotate upward in its engagement with the second hinge component 34, the latch 42 will rotate upward from the force of a spring during movement of the member 44 with the upper section of the door translating toward the top of the jamb. The force to move the upper door, and thereby move the member 44, disengages it from the latch 42 allowing the spring operatively engaged with the latch 42, to rotate the latch 42 upward as in FIG. 5c.

In operation to separate, the biased rotation of the latch 42 thereby positions a gap or space, sized for passage of the member 44 therethrough, to allow the disengagement of the member 44 positioned on the first hinge component 32. Thus, the member 44 of the first hinge component 32 slides from the rotated latch 42 of the second hinge component 34, disconnecting the pivoting connection between the hinge components formed by the latch 42 and member 44, as the upper portion 14 of the door 16 is raised to the open position of FIG. 1.

Other releasable pivoting connections between the first hinge component 32 and second hinge component 34 may be used as well, and any such releasable pivoting connection, where an actuator 59 such as a gear train, or handle, or motor or the like, actuates to disengage the pivoting components and allow separation of the first hinge component 32 from the second hinge component 34, to thereby allow a sectional door to separate, as would occur to those skilled in the art, is considered within the scope of this invention.

FIG. 6 depicts the separable hinge 28 of FIGS. 3-5 in the engaged position forming the releasable pivoting engagement between the member 44 on the first hinge component 32 and the latch 42 on the second hinge component 34, of the separable hinge 28. As noted configured in this engaged position, with the pin 51 which is spring biased into a locking engagement with the latch 42 to prevent rotation, the upper portion 14 of the door 16 will remain in a pivoted connection to the lower portion 12, and the entire door 16 can be elevated or lowered as a single unit.

It should be noted that the separable hinge 28, can be returned from the unlatched position such as in FIG. 5c, to the engaged position, by the force of the upper door acting on the member 44, which will engage with the biased latch 42 and cause it to rotate closed to a point where the biased pin 51 riding on the side edge of the latch 42, will re-engages the slot 53 to lock the latch 42. The positioning member 62, which as noted is biased toward the pin 51 by a biasing member or spring 57, and which temporarily holds the pin 51 disengaged from the latch 42, is translated to release from the pin 51 by the plate 67, when the latch 42 was fully rotated open. Thus the positioning member 62 is already released from engagement with the pin 51, thereby allowing the pin 51 to re engage with the rotating latch 42.

In FIG. 6a is shown the device herein where the separable hinge 28 is in a perspective view of the separable hinge actuated to move to the disengageable configuration of FIG. 5b, but in a perspective view with some of the parts removed for ease of description. From the locked configuration of FIG. 5a, the separable hinge 28, is actuatable to an unlocked configuration shown in FIG. 6a by translation of the pin 51 out of engagement with the slot 53 formed in the rotating latch 42. Such is accomplished herein by an actuator 59 which will impart force exceeding the spring or biasing member 57 to the pin 51 and thereby translate it from engagement with the slot 53.

As the pin 51 is translated out of engagement with the slot 53, the positioning member 62 temporarily engages with the pin 51 to hold it disengaged from the slot 53. This allows the spring biased latch 42, to rotate upward and disengaged from the member 44 as the member 44 moves upward with the upper half of the door.

Once the spring biased latch 42 fully rotates upward, the plate 67 will contact the positioning member 62, and disengage it from the pin 51 which will allow the spring biased pin 51 to translate and contact the edge of the latch 42 where it will be ready to re engage the slot 53, when the latch 42 rotates downward to engage the member 44. As noted herein, the actuator 59 to release the pin 51 can be hand operated, or otherwise operated to disengage the pin 51 and allow for disengagement of the separable hinges 28 connecting the two halves of the rolling door. Such for instance, can be a simple slide connected to the pin 51 to translate it out of the slot 53. Actuation as shown in FIG. 6a, using motor 61 can be accomplished in the other modes described herein also.

As shown in FIG. 6a, an electric motor 61 is operatively engaged with a gear train providing gear reduction to increase torque. A geared engagement 73, between gear teeth 75 on a sliding member 77, and a secondary gear (not shown) to the on a rearward side of a reduction gear 79 engaged with a the motor gear 71, allows for the translation of the sliding member 77 impart sufficient force to translate the pin 51 away from its biased positioning in the slot 53 of the rotating latch 42. In the mode of the actuator shown in FIG. 6a, the electric motor 61 will be operatively engaged with electric power either from a battery or AC power, and can be energized to rotate in one direction or the other, by a remote control device, sending RF signals to an onboard controller connecting the motor 61 to electric power.

With the pin 51 translated by force exceeding the bias of the biasing member 57 or spring, to a disengaged position as in FIG. 6a, a rolling or translating of the upper portion 16 of the sectional door 16 in a direction away from the lower portion 12, will allow the spring biased latch 42 to rotate upward during disengagement of the member 44 which is operatively engaged with the upper portion 16 of the door. Moving the upper portion 16 of the door to a position adjacent or in contact with the lower portion 12 subsequently, will contact the member 44 and latch 42 to cause the rotating latch 42 to rotate back to the position shown in FIG. 6a, whereupon the bias from the biasing member 57 or spring will urge the pin 51, which was disengaged from the positioning member 62 by the plate 67, to slide back into the slot 53 and lock the latch 42 in a rotational engagement with the member 44 connected to the upper portion 16 of the door. While depicted as in FIG. 6a and other herein, as a particularly preferred mode of the separable hinge, it should be noted that other modes of a separable hinge for a roll-up garage door may be conceived by those skilled in the art on reading this disclosure and all such other modes where two portions of a separable hinge may be separated by an actuator are considered within the scope of this patent.

As noted above, the device herein in all modes, may be provided with a lock 30, to maintain the lower portion 12 of the door 16 in fixed position in its rolling engagement in the doorjamb 15. One mode of such a lock is shown in FIGS. 7 and 8, where the lock is actuatable to a locked position such as in FIG. 7, where a latch 50 and a translating member 52 are in a locked engagement, from the unlocked position of FIG. 8. With the latch 50 engaged to one of the door 16 or jamb 15 and the translating member 52 engaged to the other of the door 16 or jamb 15, the lower portion 12 of the door 16 is prevented from moving in its rolling engagement in the doorjamb 15. When the lock 30 is actuated to an unlocked position of FIG. 8, movement of the lower portion 12 of the sectional door 16 is again possible. The translating member 52 in FIGS. 7 & 8 can also self-retract using the bias of a linear tension spring engaged to the member 52 biasing the extended member 52 toward an unlocked position. Unlocking would occur when the lower garage door half is pushed downward by the upper half, which changes the downward angle holding the member 52 in engagement with the latch 50, thus releasing the lock therebetween preventing the spring from retracting member 52.

The actuation between locked and unlocked positions can be automatic in the powered mode, such as with solenoids or linear motors translating the translating member 52, but can be manually operated also by the user simply sliding the translating member 52. In an automatic mode, once the upper half of the sectional door is lowered and joined to the lower half, solenoids or linear motors will actuate to translate the translating member 52 to the unlocked position of FIG. 8. Automatic locking would occur in reverse and locking would be actuated before separation of the two halves.

The lock 30 in all modes of the invention can be tied into the operation of the separable hinges 28, such that when the separable hinges 28 are actuated to the disengaged configuration, an automatic actuator such as a solenoid or linear electric motor or motor with rack and pinion engagement can be used to translate the translating member 52, between the locked and unlocked positions.

In this mode, if electric motors are employed to operate the actuator to disengage the pin and latch of the separable hinges 28, the automatic actuator engaged to the translating member 52, will position it to the locked position to maintain the lower portion 12 of the door 16 in place. Conversely, if the separable hinges 28 are actuated to an engaged configuration, the translating member 52 will be translated to an unlocked configuration to allow the entire door 16 to be elevated as a single unit.

Alternatively, the lock 30 may be configured as translating members operatively engaged with the separable hinges 28 such as in FIGS. 9-11 wherein a translating member 52, will move to engage the latch 50 during actuation of the separable hinges 28, to the disengaged configuration. So engaged, as in FIG. 11 for example, the lower portion 12 of the door 16 is held stationary while the upper portion 14 is moved in the roller 19 and track 21 engagement.

As noted above, FIGS. 9-11 depict a mode of the device herein, employing a centrally located separable hinge 28 in the plurality, which is operably engaged to actuate adjoining separable hinges 28 in which are also in pivoting engagement between the upper portion 14 and lower portion 12 of the door 16. While actuation to unlock one hinge 28, such as the centrally located separable hinge 28 is shown as using a hand-activated actuator shown as a handle 60, the earlier noted electric motor could also be engaged to the centrally located hinge for such activation, or, an external handle communicating through the door might also be added to allow for activation to separate the two portions of the door from outside the room.

As noted earlier, FIG. 9 depicts the plurality of separable hinges 28, where adjoining hinges 28 are tethered together such as to the centrally located hinge 28. Elongated members 29 are engaged between translating shafts 41 which are operatively engaged with gear trains on each separable hinge 28, such that all three separable hinges 28, can be actuated to unlock each spring biased pin 51, and move to the disengaged configuration such as in FIGS. 5, and 9-10, by a rotation of the gear train of one of the three hinges 28 engaged with the shafts 41. FIG. 10 depicts the plurality of hinges moved to a separable configuration by rotation of the handle on the centrally located hinge 28 in the plurality, operatively connected to the others by the members 29 to actuate them to the same configuration.

Also shown in FIGS. 9-10, are the automatic locks 30 provided engaging the translating members 50 to extend and engage the latches 52, when the side-positioned separable hinges 28 are actuated by the centrally located hinge 28 to unlock the pin 51, to allow the force of movement of the door to rotate to the latch 42 to the disengaged configuration. When the gear train of the centrally located hinge 28 is actuated to rotate by the handle 60, or as noted using a motor or the like, the elongated members 29 extending between translating engagements with each hinge 28, translate in opposing directions and cause actuations of the gear trains of the side-positioned hinges 28, to move to the unlocked configuration, and concurrently, translate the members 50 into the latches 52, to lock the lower portion 12 of the door in position as shown in FIGS. 10-11.

Separation of the upper portion 14 of the door 16 from the lower portion 12, is shown in a fashion typical to all modes of the system herein in FIG. 11, which also depicts the locking members 50 moved to form a lock 30 with their engagement to the latches 52. Of course such locking members 50 as noted might also be included in the separable hinges 28 of FIGS. 3-6 using electric powered actuation of the separable hinges 28 between engaged and disengaged configurations.

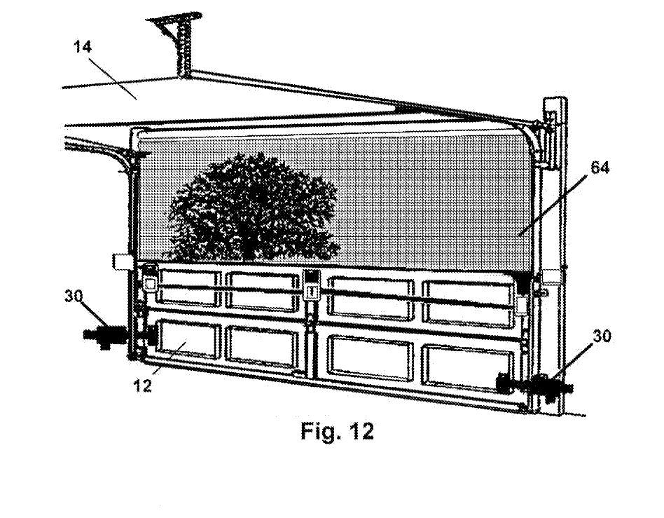

Shown in FIG. 12 is an optional component of the system herein, deplorable screen 64 to fill the opening between the lower portion 12 of the door 16 and the door jamb once the upper portion 14 of the door has been raised.

While all of the fundamental characteristics and features of the sectional door separation system herein have been shown and described herein, with reference to particular embodiments thereof, a latitude of modification, various changes and substitutions are intended in the foregoing disclosure and it will be apparent that in some instances, some features or steps in the invention may be employed without a corresponding use of other features or steps without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A sectional door hinge system comprising:
said hinge having a first hinge component adapted for engagement to an upper portion of a sectional roll-up door;
said hinge having a second hinge component adapted for engagement to a lower portion of said sectional roll-up door;
said hinge having an engaged position wherein said first hinge component is held in a removable pivoting engagement with said second hinge component;
said hinge having a disengaged position wherein said first hinge component is separable from said second hinge component; and
an actuator, said actuator operable to release said first hinge component from said removable pivoting engagement with said second hinge component, whereby said upper portion of said sectional door is translatable on a track in a direction away from said lower portion of said sectional door, to a position forming a gap between said upper portion and said lower portion of said sectional roll-up door.

2. The sectional door hinge system of claim 1, wherein said removable engagement between said first hinge component and said second hinge component comprises a connection between a member positioned on one of said first hinge component or said second hinge component, and a latch, said latch positioned to a latch engagement with the other of said first hinge component or said second hinge component.

3. The sectional door hinge system of claim 2 additionally comprising:
said latch being rotationally engaged at said latch engagement, said latch rotatable between a first position with said latch encircling said member and holding said hinge in said engaged position, and a second position, with said latch rotated to a position disengaged from said member;
said actuator operable for disengaging a connection preventing rotation of said latch from said first position; and
said latch rotatable to said second position by contact against said member during a translation of said upper door portion away from said lower door portion.

4. The sectional door hinge system of claim 3 additionally comprising:
said connection being a pin in an engagement with a slot formed in said latch;
said actuator moving said pin from said engagement with said slot, to a disengaged position; and
said latch being rotatable to said second position only with said pin in said disengaged position.

5. The sectional door hinge system of claim 3, additionally comprising:
a lock engageable between said lower door portion and said door jam.

6. The sectional door hinge system of claim 4, additionally comprising:
a lock engageable between said lower door portion and said door jam.

7. A sectional door hinge system, configured for engagement with a sectional door in a rolling engagement upon a track positioned on opposing sides of a door jamb, comprising:
a first plurality of pivotally engaged door sections defining an upper portion of said sectional door;
a second plurality of pivotally engaged door sections defining a lower portion of said sectional door;
a lower edge of said upper portion of said sectional door abutting a separation edge of said lower portion of said sectional door;
a plurality of hinges engaged between said lower edge of said upper portion of said sectional door, and said separation edge of said lower section of said sectional door;
each said hinge in said plurality having a first hinge component engaged to said upper portion of said sectional door;
each said hinge in said plurality having a second hinge component engaged to said lower portion of said sectional roll-up door;
each said hinge in said plurality having an engaged position wherein said first hinge component is in a removable pivoting engagement with said second hinge component;
each said hinge in said plurality having a disengaged position wherein said first hinge component is separable from said second hinge component;
an actuator, said actuator operably engaged with each of said hinges in said plurality of hinges, said actuator operable to disengage a connection holding said hinges in said engaged position and render said hinges to said disengaged position;
movement of said upper portion of said sectional door in a direction away from said lower portion, with each of said plurality of hinges in said disengaged position, communicating a force to each said hinge to separate each said first hinge components from a respective second hinge component, whereafter said upper portion of said sectional door is separable from said lower portion of said sectional door and translatable to form a gap between said lower edge of said upper portion and said separation edge of said lower portion of said sectional door.

8. The sectional door hinge system of claim 7 additionally comprising:
each respective said pivoting connection being formed between a member engaged with one of said first hinge component and said second hinge component, and a latch connected to the other of said first hinge component and said second hinge component;
each said latch positionable between a first position in a pivoting engagement with a respective said member and a second position, with said latch disengaged from said member;
said connection maintaining that latch in said first position; and
said actuator operably engaged with each of said hinges in said plurality of hinges, said actuator operable to disengage said connection maintaining said latch in said first position, whereby said force when communicated to each said latch from a respective said member during said translation of said upper portion of said sectional door away from said lower portion, moves said latch to said second position thereby rendering said hinges to said disengaged position.

9. The sectional door hinge system of claim 8 additionally comprising:
each said connection being a pin in an engagement with a slot formed in a respective said latch;
said actuator moving said pin from said engagement with said slot, to a disengaged position;
said latch being rotatable to said second position only with said pin in said disengaged position;
said actuator including a gear train engaged with a translating member communicating with said pin to move it to said disengaged position;
an electric motor operatively connected to rotate each said gear train and disengage said connection; and
a remote control for signaling a switch to connect electric power to each said electric motor, whereby each said pin of each of said plurality of hinges is concurrently moved to said disengaged position.

10. The sectional door hinge system of claim 9 additionally comprising:
a latch member positioned at said lower portion of said sectional door; and
said latch movable from an engaged position in an engagement with a latch on or adjacent said door jamb, to a disengaged position separated from contact with said latch, whereby with said latch moved to said engaged position with said plurality of hinges concurrently in said disengaged position, said lower portion of said sectional door is locked in position at lower end of said door jamb by said latch in said engaged position.

11. The sectional door hinge system of claim 10 additionally comprising:
said a latch member translatably engaged with a said second hinge component of one of said plurality of hinges; and
operation of said actuator to disengage said connection concurrently moving said latch member to said engaged position.

12. A door hinge system for connecting upper and lower sections of a sectional garage door, comprising:
a hinge having an engaged position with a first hinge component in a pivoting engagement with a second hinge component;
said first hinge component engageable in a first engagement to an upper portion of a sectional roll-up door;
said second hinge component engageable in a second engagement to a lower portion of a sectional roll-up door;
said hinge in said engaged position maintaining said upper portion of said sectional door abutting and pivotally connected to said lower portion or said sectional door;
said hinge having a disengaged position said pivoting engagement said first engagement or said second engagement, is disconnected;
an actuator, said actuator operable to move said hinge between said engaged position and said disengaged position; and
said upper portion of said sectional roll-up door being separable from a first position abutting said lower portion of said sectional roll-up door, to a second position forming a gap between said upper portion and lower portion of said roll-up door, with said hinge actuated to said disengaged position.

13. The door hinge of claim 12, wherein a repositioning of said upper portion of said roll-up door to said first position, actuates said actuator to move said hinge to said engaged position.
